(19) United States
(12) Patent Application Publication
(10) Pub. No.: US 2017/0082820 A1
(43) Pub. Date: Mar. 23, 2017

(54) OPTICAL COMPONENT MOUNT SYSTEM FOR USE WITH AN OPTICAL RAIL SYSTEM

(71) Applicant: NEWPORT CORPORATION, Irvine, CA (US)

(72) Inventors: Wen Xu Jin, Laguna Hills, CA (US); Richard Michael Sebastian, Costa Mesa, CA (US)

(73) Assignee: Newport Corporation, Irvine, CA (US)

(21) Appl. No.: 15/268,583

(22) Filed: Sep. 17, 2016

Related U.S. Application Data
(60) Provisional application No. 62/220,337, filed on Sep. 18, 2015.

(51) Int. Cl. G02B 7/00; F16M 13/02

(52) U.S. Cl. CPC G02B 7/004; F16M 13/022

(57) ABSTRACT

An optical component mount system which includes an optical mount having at least one mount body. At least one optical component receiver may be formed on the mount body. The optical component receiver may be configured to receive at least one optical component therein. In addition, at least one coupling extension extends from the optical mount body. The coupling extension includes at least one coupling receiver formed therein. The coupling receiver is configured to receive at least a portion of at least one optical rail body therein. In one embodiment, the coupling receiver and optical component receiver are co-aligned along a common longitudinal axis of the optical mount.

### CROSS REFERENCE TO RELATED APPLICATIONS

The present application claims priority to U.S. Provisional Patent Appl. Ser. No. 62/220,337, entitled “Optical Component Mount System for Use with an Optical Rail System,” filed on Sep. 18, 2015, the entire contents of which are incorporated by reference herein.

### BACKGROUND

Optical components such as lenses, mirrors, gratings, and the like are used in a wide variety of applications. Typically, these components are positioned on or coupled to an optical mount device configured to support and position the optical component at a desired location. Complex optical systems may be comprised of multiple optical subsystems positioned on one or more optical benches or tables, wherein the optical subsystems may include a wide variety of optical components/detectors, sensors, meters, and the like. Often, repositioning one optical subsystem and/or one or more optical component within the optical system is challenging and may require a time-consuming and labor intensive realignment of a portion of, if not the entire, optical system.

In light of the foregoing, optical rail systems have been developed which permit the easy assembly, alignment, and partitioning of optical systems and subsystems. For example, the OpticsCage™ optical cage system and A-Line™ self-aligning lens mounts manufactured by the Newport Corporation permit the user to easily and repeatably construct optical systems and subsystems which may be easily inserted into and/or removed from an optical system or work area. While these device have proven useful in the past, on occasion remove of a single optical component from the rail system has proven challenging. For example, adding and/or removing an optical component from a medial position within a complex optical subassembly may require remove of addition optical components.

In light of the foregoing, there is an ongoing need for an optical mount system configured to permit a user to easily add, align, and remove optical components from an optical rail system.

### SUMMARY

The present application is directed to an optical component mount system for use in coupling one or more optical components to one or more optical rail systems. In one embodiment, the optical component mount system includes an optical mount having at least one mount body. At least one optical component receiver may be formed on the mount body. The optical component receiver may be configured to receive at least one optical component therein. In addition, at least one coupling extension extends from the optical mount body. The coupling extension includes at least one coupling receiver formed therein. The coupling receiver is configured to receive at least a portion of at least one optical rail body therein. In one embodiment, the coupling receiver and optical component receiver are co-aligned along a common longitudinal axis of the optical mount.

In another embodiment, the present application is directed to an optical component mount system for use with at least one optical rail system. More specifically, the optical component mount system may include at least one mount body having at least one optical component receiver formed therein. The optical component receiver is configured receive at least one component support body configured to support at least one optical component therein. At least one component positioning device is positioned on the mount body. The component positioning device traverses through the optical mount body and engages at least a portion of the component support body. During use, actuation of the component positioning device results in a biasing force being applied to a component support body which results in movement of the component support body relative to the optical component receiver. At least one coupling extension extends from the optical mount body. The coupling extension has at least one coupling receiver formed therein. The coupling receiver is configured to receive at least a portion of at least one optical rail body therein, wherein coupling receiver and optical component receiver are co-aligned along a common longitudinal axis of the optical mount.

In yet another embodiment, the present application discloses an optical mount having at least one mount positioning body. The mount positioning body includes at least one coupling extension having at least one coupling receiver formed therein and configured to receive at least a portion of at least one optical rail body therein, wherein coupling receiver and optical component receiver are co-aligned along a common longitudinal axis of the optical mount. At least one mounting plate body is adjustably coupled to the mount positioning body and configured to selectively engage and support at least one optical component therein. In addition, the optical component mount system includes at least one position adjustment system coupling the mounting plate body to the mount positioning body. The position adjustment system has at least one adjustment actuator configured to traverse through a portion of the mount positioning body and selectively engage at least a portion of mounting plate body, and at least one biasing member configured to provide at least one biasing force to the mounting plate body wherein the mounting plate body is biased towards the mount positioning body.

Other features and advantages of the optical component mount system for use with an optical rail system as described herein will become more apparent from a consideration of the following detailed description.

### BRIEF DESCRIPTION OF THE DRAWINGS

Various embodiments of the optical component mount system for use with an optical rail system will be explained in more detail by way of the accompanying drawings, wherein:

FIG. 1 shows an elevated perspective view of an embodiment of an optical component mount system for use with an optical rail system wherein the coupling extension is integral to the mount body;

FIG. 2 shows an elevated perspective view of an embodiment of an optical component mount system coupled to an optical rail system;

FIG. 3 shows an elevated perspective view of an embodiment of an adjustable optical component mount system wherein the position of the optical component supported by the optical component mount may be selectively adjusted by the user;

FIG. 4 shows an elevated perspective view of another embodiment of an adjustable optical component mount system wherein the position of the optical component supported by the optical component mount may be selectively adjusted by the user;

FIG. 5 shows an elevated perspective view of another embodiment of an adjustable optical component mount system wherein the position of the optical component supported by the optical component mount may be selectively adjusted by the user;

FIG. 6 shows an elevated perspective view of an embodiment of an optical component mount system for use with an optical rail system having a positioning fixture body separable from the component positioning fixture;

FIG. 7 shows an elevated perspective view of an embodiment of the positioning fixture body used in the optical component mount system shown in FIG. 6;

FIG. 8 shows an elevated perspective view of an embodiment of an optical component mount system for use with an optical rail system wherein the coupling extension is integral to the mount body wherein the optical rail system includes at least one alignment feature thereon; and

FIG. 9 shows an elevated cross-sectional perspective view of an embodiment of the optical component mount system for use with an optical rail system shown in FIG. 8.

### DETAILED DESCRIPTION

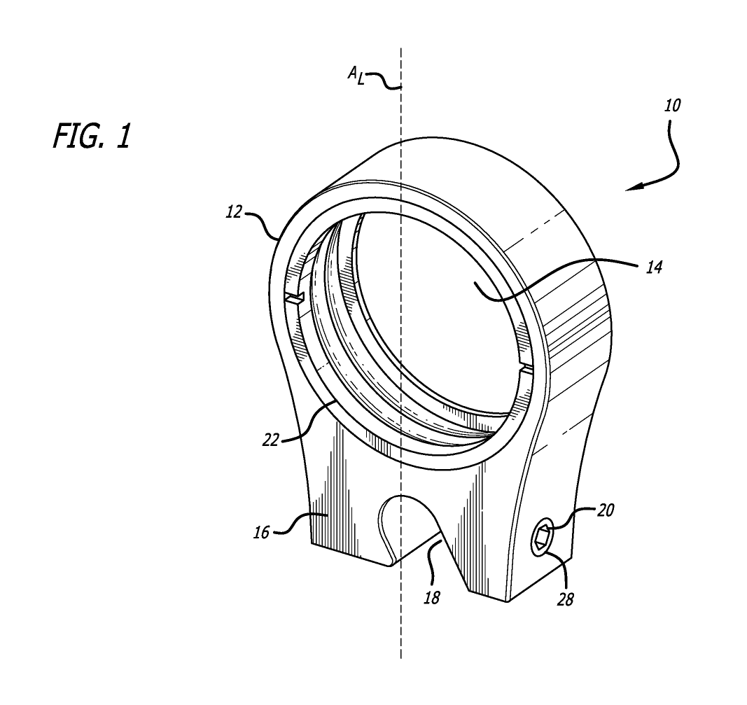

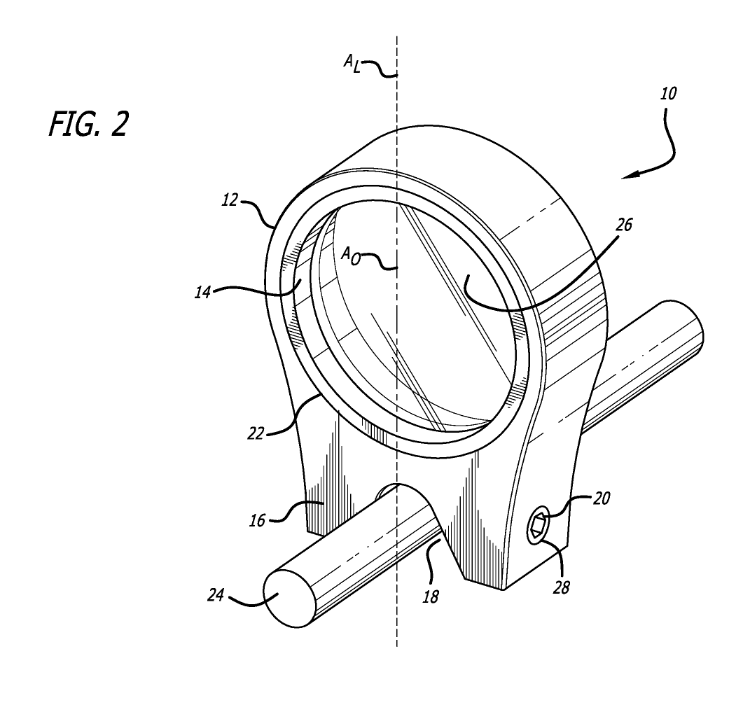

FIGS. 1 and 2 show various views of an embodiment of an optical mount for use with an optical rail system. As shown, the optical mount 10 includes at least one mount body 12 having at least one optical component receiver 14 formed therein. In the illustrated embodiment the mount body 12 includes a single component receiver 14 formed therein, although those skilled in the art will appreciate that any number of optical component receivers 14 may be formed in the mount body 12. In the illustrated embodiment, the optical mount 10, and the various components thereof, is manufactured from aluminum. In an alternate embodiment, the optical mount 10, and the various components thereof, is manufactured from one or more polymers. Optionally, the optical mount 10, and the various components thereof, is manufactured from any variety of materials, including, without limitations, alloys, polymers, elastomers, composite materials, various metals, and the like. Further, FIGS. 1 and 2 show an embodiment of an optical mount 10 wherein the mount body 12 comprises a monolithic structure.

Referring again to FIGS. 1 and 2, in the illustrated embodiment, the component receiver 14 is generally circular. Optionally, the component receiver 14 may be formed in any variety of shapes. In the illustrated embodiment, the component receiver 14 comprises an open aperture configured to receive one or more lens, optical filters, and/or similar transmissive or refractive components therein. In an alternate embodiment, the component receiver 14 need not include an open aperture. For example, the component receiver 14 may be configured to have one or more non-transmissive optical elements positioned therein or coupled thereto. As such, the component receiver 14 may include a wall member (not shown) configured to receive one or more non-transmissive optical components thereon. For example, the optical mount 10 may be configured to support one or more mirrors, diffraction gratings, sensors, or similar non-transmissive components therein. As such, the optical mount 10 may include an open or non-occluded component receiver 14 configured to support and position one or more transmissive elements therein or, in the alternative, a closed or occluded component receiver 14 configured to support and position one or more reflective or diffractive components therein.

Referring again to FIGS. 1 and 2, the optical mount 10 includes at least one coupling extension 16 formed on or coupled to the mount body 12. As shown, the one or more coupling receiver 18 is formed on the coupling extension 16. As stated above, the coupling extension 16 having the coupling receiver 18 may be integral to the mount body 12, thereby forming a monolithic body. Optionally, the coupling extension 16 may be separable from the mount body 12. In the illustrated embodiment, a single coupling receiver 18 is formed on the coupling extension 16. In an alternate embodiment, multiple coupling receivers 18 are formed on the coupling extension 16. As shown in FIG. 1, the coupling receiver 18 may be co-aligned along the longitudinal axis A_{L}of the component receiver 14. As such, the coupling receiver 18 and component receiver 14 are aligned along a common longitudinal axis A_{L}. As a result, the longitudinal axis A_{O} of at least one optical component 26 positioned with the component receiver 14, and retained therein by at least one component retaining device 22 is positioned co-aligned with the longitudinal axis A_{L} of the component receiver 14 and the coupling receiver 18 of the optical mount 10. Optionally, those skilled in the art will appreciate that the longitudinal axis A_{O} of at least one optical component 26 positioned within the component receiver 14 need not be positioned co-aligned with the longitudinal axis A_{L} of the component receiver 14 and the coupling receiver 18 of the optical mount 10.

Referring again to FIGS. 1 and 2, the optical mount 10 may include at least one coupling fastener 20 positioned within at least one fastener passage 28 configured to selectively couple the optical mount 10 to at least one optical mount rail or rod device 24 positioned within the coupling receiver 18 formed on the coupling extension 16. In the illustrated embodiment, a single coupling fastener 20 is positioned within a single fastener passage 28 although those skilled in the art will appreciate that any number of fasteners 22 may be positioned within any number of fastener passages 28 formed on the optical mount 10.

As shown in FIGS. 1 and 2, at least one component retaining device 22 may be used to securely position at least one optical components or similar device within the component receiver 14. In one embodiment, the component retaining device 22 comprises at least one threaded ring or similar device configured to engage the mount body 12 in threaded relation. Optionally, any variety of alternate devices and methods may be used to securely couple or position the optical mount 10 to one or more optical components 26.

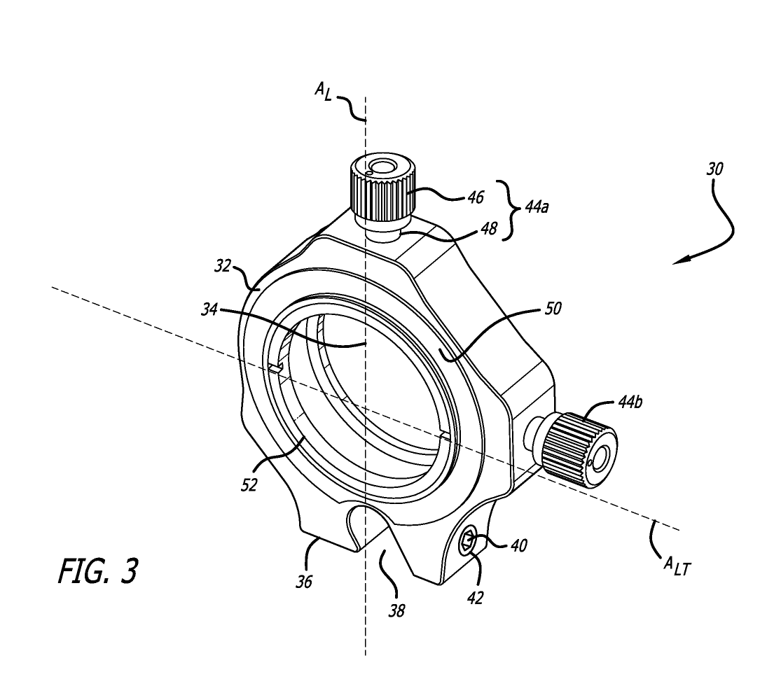

FIG. 3 shows another embodiment of an optical mount for use with an optical rail system. As shown, the optical mount 30 includes a mount body 32 defining at least one component receiver 34 therein. Like the previous embodiment, those skilled in the art will appreciate that the component receiver 34 may be formed in any variety of shapes to accommodate any variety of optical components or devices coupled to or in communication with the optical mount 30. Further, at least one coupling extension 36 extends from at least a portion of the mount body 32 of the optical mount 30. Optionally, the coupling extension 36 may be integral to the mount body 32, thereby forming an integral or monolithic body. In another embodiment, the coupling extension 36 is separable from the mount body 32 Like the previous embodiment, the coupling extension 36 includes at least one coupling receiver 38 formed therein. In one embodiment, the coupling receiver 38 is positioned along the longitudinal axis A_{L} of the mount body 32 of the optical mount 30, although those skilled in the art will appreciate that the coupling receiver 38 may be positioned anywhere on the mount body 32. Further, the optical mount 30 may include one or more fastener receivers 40 having one or more fasteners 42 positioned therein, thereby permitting the optical mount 30 to be detachably and movably coupled to one or more optical rails, rods, or similar opto-mechanical positioning devices or systems.

Referring again to FIG. 3, the optical mount 30 includes at least one component positioning system thereon. In the illustrated embodiment, the optical mount 30 includes multiple component positioning systems 44a, 44b positioned on the mount body 32. As shown, the component positioning systems 44a, 44b include at least one adjustment device 46 positioned within at least one adjustment device aperture 48. The adjustment device 46 is configured to engage and controllably position at least one component support body 50 located within or coupled to the component receiver 34 formed in the mount body 32 of the optical mount 30. The component support body 50 and component retaining device 52 are configured to engage and couple at least one optical component (not shown) to the optical mount 30. In the illustrated embodiment, the component positioning systems 44a, 44b permit the user to easily couple one or more optical component to the optical mount 30. In another embodiment, the component positioning systems 44a, 44b permit the user to selectively adjust the position of an optical component (not shown) supported by the optical mount 30 relative to the longitudinal axis A_{L} of the optical mount 30, the lateral axis A_{LT} of the optical mount 30, or both. For example, actuation of at least one component positioning systems 44a, 44b may result in a biasing force being applied to the component support body 50, thereby resulting in the controlled movement of the component support body 50 retaining the optical component therein within the component receiver 34.

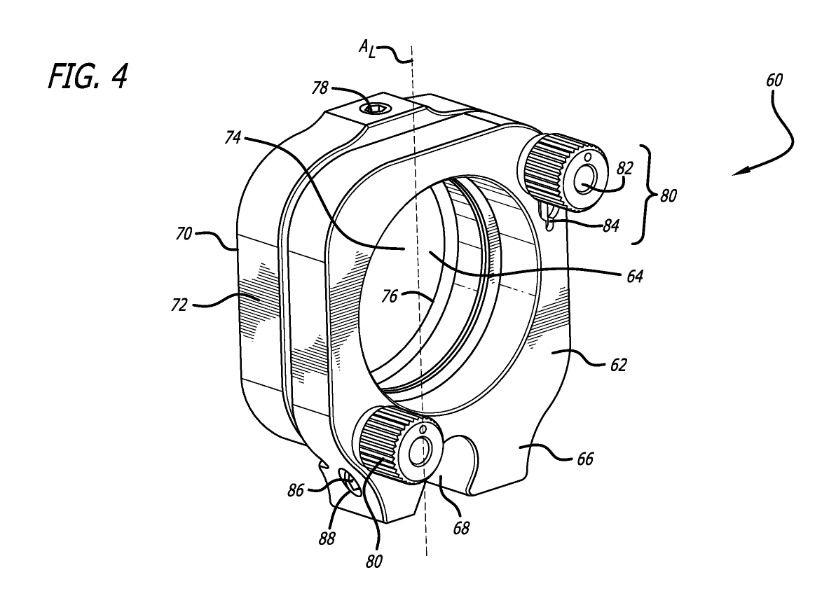

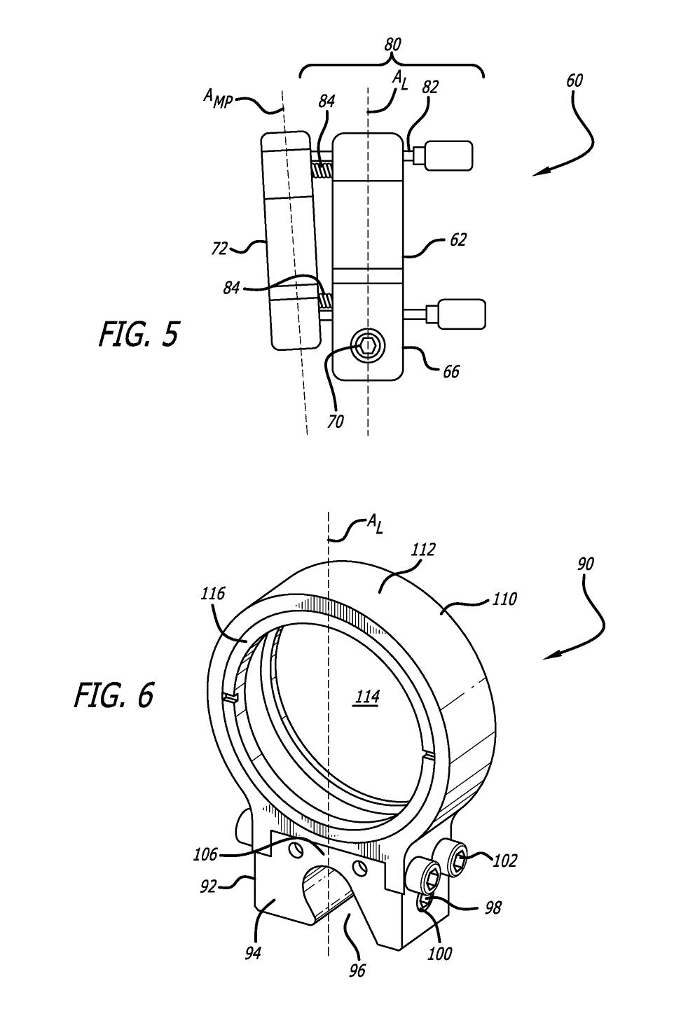

FIGS. 4 and 5 show yet another embodiment of an optical mount for use with an optical rail system. As shown, the optical mount 60 includes a mount positioning body 62 defining at least one passage 64 therein. Like the previous embodiments, those skilled in the art will appreciate that the passage 64 may be formed in any variety of shapes. Further, at least one coupling extension 66 extends from at least a portion of the mount positioning body 62 of the optical mount 60. Optionally, the coupling extension 68 may be integral to the mount positioning body 62. Like the previous embodiments, the coupling extension 66 includes at least one coupling receiver 68 formed therein. In one embodiment, the coupling receiver 68 is positioned along the longitudinal axis A_{L} of the mount positioning body 62 of the optical mount 60, although those skilled in the art will appreciate that the coupling receiver 68 may be positioned anywhere on the mount positioning body 62. Further, the optical mount 60 may include one or more fastener receivers 88 having one or more fasteners 86 positioned therein, thereby permitting the optical mount 60 to be detachably and movably coupled to one or more optical rails, rods, or similar opto-mechanical positioning devices or systems.

Referring again to FIGS. 4 and 5, the optical mount 60 includes at least one component mounting plate 70 movably coupled to the mount positioning body 62. The component mounting plate 70 may include at least one component mounting plate body 72 having at least one aperture 74 formed therein. Optionally, the component mounting plate 70 need not include an aperture 74 formed in the component mounting plate body 72. As shown in FIG. 4, at least one component retaining device 76 may be positioned within the aperture 74 or may be detachably coupled to the component mounting plate body 72. The component retaining device 76 may be configured to enable one or more optical components or similar devices to be coupled to the optical mount 60. Further, the optical mount 60 may include one or more fasteners 78 configured to engage the component retaining device 74 thereby further securing the component (not shown) when positioned on or within the optical mount 60.

Referring again to FIGS. 4 and 5, at least one position adjustment system 80 may be positioned on or included with the optical mount 60. In one embodiment, the position adjusting system 80 comprises at least one adjustment member 82 positioned within at least one actuator passage (not shown), traverses through the mount positioning body 62, and selectively engages the mounting plate body 72. In the illustrated embodiment, the position adjusting system 80 comprises any variety of devices, including, without limitations, rods, threaded bodies, springs, biasing members, pins, and the like. For example, in the illustrated embodiment, the position adjusting system 80 comprises the adjustment member 82 which comprises at least one threaded rod and at least one biasing member 84 configured to engage the component mounting plate 70 to the mount positioning body 62 using a kinematic mounting architecture. In the alternative, those skilled in the art will appreciate that any variety of movable mounting architectures coupled be used with the optical mount 60. Further, the optical mount 60 includes one or more fasteners 86 positioned within one or more fastener receivers 88 formed in the mount positioning body 62, thereby permitting the optical mount 60 to be easily coupled to one or more optical rails or similar mounts in movable relation.

As shown in FIGS. 4 and 5, actuation of the adjustment members 82 may result in the controllable movement of the component mounting body 72 relative to the positioning body 62 such that the angle of the longitudinal axis A_{MP} of the component mounting plate body 72 may be varied relative to the longitudinal axis A_{L} of the mount positioning body 62. As such, those skilled in the art will appreciate that the component mounting body 72 may be configured to extend from, retractable, tilt, pitch, and/or yaw relative to the position of the mount positioning body 62.

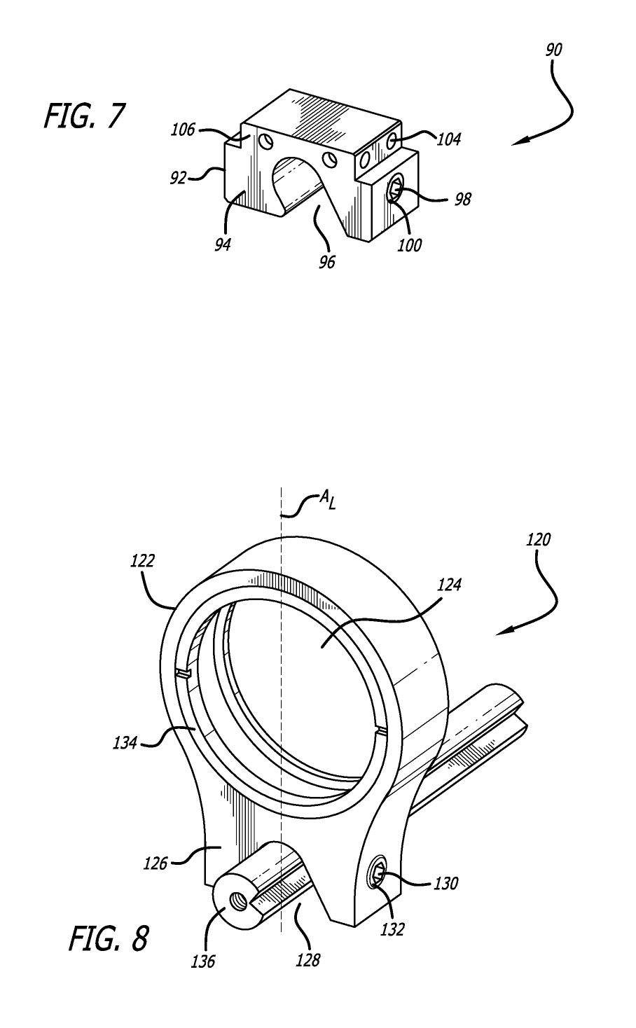

FIGS. 6 and 7 show still another embodiment of an optical mount for use with an optical rail system. As shown, the optical mount system 90 includes a mount positioning fixture 92 configured to have at least one component positioning fixture 110 detachably coupled thereto. In the illustrated embodiment, the component positioning fixture 110 is configured to support at least one lens or generally cylindrical component therein, although those skilled in the art will appreciate that the component positioning fixture 110 may be formed in any variety of shapes and configurations. For example, the component positioning fixture 110 may be configured to support one or more fiber optics devices, sensors, or similar components therein. As such, the component positioning fixture 110 may be configured to support multiple components at a desired location. Those skilled in the art will appreciate that the mount positioning fixture 92 and component positioning fixture 110 described herein may be adapted for use with any of the embodiments of the optical component mount system described in the present application.

Referring again to FIGS. 6 and 7, the mount positioning fixture 92 includes at least one positioning fixture body 94 defining at least one coupling receiver 96 therein. As shown, optionally, the coupling receiver 96 may be co-aligned with the longitudinal axis A_{L} of the component positioning fixture 110 when the component positioning fixture 110 is coupled to the mount positioning body 92 Like the previous embodiment, at least one fastener 98 may be positioned within at least one fastener receiver 100 formed in and traversing through the mount positioning fixture 92. In addition, the mount positioning fixture 92 includes one or more mount system couplers 102 configured to traverse through the component positioning fixture 110 and detachably couple to one or more coupling system receivers 104 formed on at least one coupling extension 106 positioned on the mount positioning fixture 92. In an alternate embodiment, the mount system couplers 102 comprise or more magnetic members, friction-fit devices, dovetail features and like thereby permitting the user to easily couple and de-couple the component positioning fixture 110 to and from the mount positioning fixture 92.

Referring again to FIGS. 6 and 7, the component positioning fixture 110 may include component receiving body 112 having at least one component passage 114 formed therein. At least one component retaining device 116 may be used to selectively couple at least one component to the component receiving body 112. Unlike the optical component mounts described in FIGS. 1-5 of the present application, the present embodiment permits the user to position the mounting positioning body 92 at a desired location within an optical system and quickly and repeatedly add or remove optical components to the optical components to the optical system at least same location, thereby permitting the user to change components as desired.

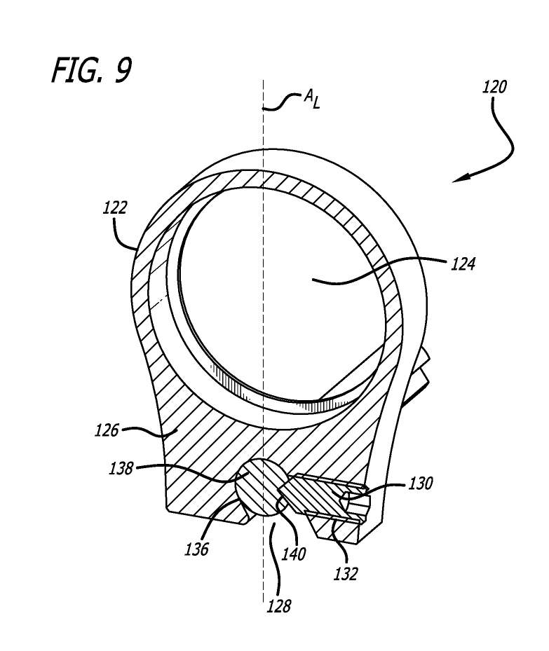

FIGS. 8 and 9 show various views of another embodiment of an optical mount for use with an optical rail system. Like the previous embodiment shown in FIGS. 1 and 2, the optical mount 120 includes at least one mount body 122 having at least one optical component receiver 124 formed therein. Further, the optical mount 120 includes at least one coupling extension 126 formed on or coupled to the mount body 122. Optionally, the coupling extension 126 may be integral to the mount body 122 or may be configured to couple to and detach from the mount body 122. One or more coupling receivers 128 may be formed on the coupling extension 126. In the illustrated embodiment, a single coupling receiver 128 is formed on the coupling extension 126. In an alternate embodiment, multiple coupling receivers 128 are formed on the coupling extension 126. As shown in FIGS. 8 and 9, the coupling receiver 128 may be co-aligned along the longitudinal axis A_{L} of the component receiver 124. As such, the coupling receiver 128 and component receiver 124 may share a common longitudinal axis A_{L}. As a result, the longitudinal axis of at least one optical component (not shown) positioned with the component receiver 124, and retained therein by at least one component retaining device 134 may be positioned co-aligned with the longitudinal axis A_{L} of the component receiver 124 and the coupling receiver 128 of the optical mount 120. Optionally, those skilled in the art will appreciate that the longitudinal axis A_{L} of at least one of the optical component (not shown) positioned within the component receiver 124 need not be positioned co-aligned with the longitudinal axis A_{L} of the component receiver 124 and the coupling receiver 128 of the optical mount 120.

Referring again to FIGS. 8 and 9, the optical mount 120 may include at least one coupling fastener 130 positioned within at least one fastener passage 132 configured to selectively couple the optical mount 120 to at least one optical mount rail or rod device 136 positioned within the coupling receiver 128 formed on the coupling extension 126. In the illustrated embodiment, a single coupling fastener 130 is positioned within a single fastener passage 132 although those skilled in the art will appreciate that any number of fasteners 130 may be positioned within any number of fastener passages 132 formed on the optical mount 120.

As shown in FIGS. 8 and 9, at least one component retaining device 134 may be used to securely position at least one optical components or similar device (not shown) within the component receiver 124. In one embodiment, the component retaining device 134 comprises at least one threaded ring or similar device configured to engage the mount body 122 in threaded relation. Optionally, any variety of alternate devices and methods may be used to securely couple or position the optical mount 120 to one or more optical components.

As shown in FIGS. 8 and 9, in the illustrated embodiment the optical mount rail 136 is positioned within and traverses through the coupling receiver 128. As shown in FIG. 9, the optical mount rail 136 includes a rail body 138 having one or more alignment features 140 formed thereon or therein. In the illustrated embodiment the alignment feature comprises at least one indent configured to receive at least a portion of the fastener 130 therein. As such, in one embodiment the alignment feature 140 may be orthogonal to the longitudinal axis A_{L} of the component receiver 124 and the coupling receiver 128 of the optical mount 120. Optionally, any variety of alignment features 140 having any variety of shapes and configurations may be formed on the optical mount rail 136. For example, in one embodiment, the alignment feature 140 comprises one or more planar faces. Optionally, the alignment feature 140 may include various alignment aids or marks, measuring devices or marks, fiducials, and the like.

The embodiments disclosed herein are illustrative of the principles of the invention. Other modifications may be employed which are within the scope of the invention. Accordingly, the devices disclosed in the present application are not limited to that precisely as shown and described herein.

What is claimed is:

1. An optical component mount system for use with an optical rail system, comprising:
an optical mount having at least one mount body, the optical mount body having at least one optical component receiver formed therein, the optical component receiver configured to receive at least one optical component therein;
at least one coupling extension extending from the optical mount body, the coupling extension having at least one coupling receiver formed therein, the coupling receiver configured to receive at least a portion of at least one optical rail body therein, wherein coupling receiver and optical component receiver are co-aligned along a common longitudinal axis of the optical mount.

2. The optical component mount system of claim 1 wherein the optical component receiver formed in the optical mount body comprises an open aperture.

3. The optical component mount system of claim 1 wherein the optical component receiver formed in the optical mount body comprises a non-open aperture configured to receive one or more non-transmissive optical components therein.

4. The optical component mount system of claim 1 wherein the coupling extension is integral to the optical mount body thereby forming a monolithic body.

5. The optical component mount system of claim 1 wherein the coupling extension is selectively detachable from the optical mount body.

6. The optical component mount system of claim 5 further comprising:
at least one mount positioning fixture having at least one coupling receiver formed therein, the coupling receiver configured to selectively engage and be retained on an optical rail device; and
at least one component positioning fixture configured to be selectively coupled to and detachable from the mount positioning fixture, the component positioning fixture having at least one optical component receiver formed therein.

7. An optical component mount system for use with an optical rail system, comprising:
an optical mount having at least one mount body, the mount body having at least one optical component receiver formed therein;
at least one component support body retaining at least one optical component therein, the component support body retained within the optical component receiver formed in the mount body;
at least one component positioning device positioned on the mount body, the component positioning device traversing through the optical mount body and engaging at least a portion of the component support body wherein actuation of the component positioning device results in a biasing force being applied to a component support body resulting in movement of the component support body relative to the optical component receiver; and
at least one coupling extension extending from the optical mount body, the coupling extension having at least one coupling receiver formed therein, the coupling receiver configured to receive at least a portion of at least one optical rail body therein, wherein coupling receiver and optical component receiver are co-aligned along a common longitudinal axis of the optical mount.

8. The optical component mount system of claim 7 wherein the coupling extension is integral to the optical mount body thereby forming a monolithic body.

9. The optical component mount system of claim 7 wherein the coupling extension is selectively detachable from the optical mount body.

10. An optical component mount system for use with an optical rail system, comprising:
an optical mount having at least one mount positioning body, the mount positioning body having at least one coupling extension extending therefrom, the coupling extension having at least one coupling receiver formed therein, the coupling receiver configured to receive at least a portion of at least one optical rail body therein, wherein coupling receiver and optical component receiver are co-aligned along a common longitudinal axis of the optical mount.
at least one mounting plate body adjustably coupled to the mount positioning body and configured to selectively engage and support at least one optical component therein; and
at least one position adjustment system coupling the mounting plate body to the mount positioning body, the position adjustment system having at least one adjustment actuator configured to traverse through a portion of the mount positioning body and selectively engage at least a portion of mounting plate body, and at least one biasing member configured to provide at least one biasing force to the mounting plate body wherein the mounting plate body is biased towards the mount positioning body.

11. The optical component mount system of claim 10 wherein the coupling extension is integral to the optical mount body thereby forming a monolithic body.

12. The optical component mount system of claim 10 wherein the coupling extension is selectively detachable from the optical mount body.

13. The optical component mount system of claim 10 wherein the position adjustment system comprises a kinematic coupling system configured to couple the mounting plate body to the mount positioning body.

14. The optical component mount system of claim 10 further comprising at least one component retaining device positioned on the mounting plate body, the component retaining device configured to securely and selectively couple at least one optical component to the mounting plate body.
